(19) United States
(12) Patent Application Publication
(10) Pub. No.: US 2020/0135020 A1
(43) Pub. Date: Apr. 30, 2020

(54) Autonomous Control Method for Actuated Coordinated Signals

(71) Applicant: DALIAN UNIVERSITY OF TECHNOLOGY, Dalian City (CN)

(72) Inventors: Hongfeng XU, Dalian City (CN); Kun ZHANG, Dalian City (CN); Qiming ZHENG, Dalian City (CN)

(21) Appl. No.: 16/725,216

(22) Filed: Dec. 23, 2019

Related U.S. Application Data
(63) Continuation of application No. PCT/CN2018/110232, filed on Oct. 15, 2018.

(30) Foreign Application Priority Data
May 3, 2018 (CN) 201810440056.7

(51) Int. Cl. G08G 1/083; G08G 1/08; G08G 1/01; G08G 1/095

(52) U.S. Cl. CPC G08G 1/083; G08G 1/08; G08G 1/095; G08G 1/0125; G08G 1/0145

(57) ABSTRACT

An autonomous control method for actuated coordinated signals. Specifically, the background plans are created for all the intersections once per time step. Each time step includes consecutive N cycles. First, the base splits are allocated to the coordinated and uncoordinated phases in proportional to their expected base splits. Second, the base phase offset brings into effect accurately. When the signal controller receives the new background plan from the control center, it transitions the background plans from the old one to the new one, and times the permissive cut-off portions and the force-off points in each cycle of the next time step. The autonomous control method for actuated coordinated signals can automatically create the timing parameters for actuated coordinated signals to accommodate the short-term variation in the vehicle demand without any manual intervention.

### TECHNICAL FIELD

The present invention belongs to the field of intelligent traffic control, and relates to an autonomous control method for actuated coordinated signals.

### BACKGROUND

Arterial signal coordination is a term meaning that traffic signals at closely spaced intersections along an arterial are coordinated to operate as a group. It allows high-priority vehicle movements from an intersection to perceive less travel time and less number of stops at downstream intersections. With a high penetration of vehicle detection systems, actuated signal coordination is gradually replacing fixed signal coordination and is becoming the main technical form of urban traffic signal control systems.

Actuated signal coordination is a control technique that adds a layer of actuated logic to background timing plans for coordinated signals, i.e., background plans. The background plan structures the basic time relationships among signal phases at an intersection and between coordinated phases at adjacent intersections. The actuated logic dynamically adjusts the green durations of coordinated and uncoordinated phases.

The methods for creating timing plans for fixed coordinated signals can usually be used to create the background plans. Over the past decades, comprehensive and deep research effort has been done to refine time-of-day (TOD) schedule, minimize systemwide average vehicle delay, maximize progression bandwidth, and expedite and smooth plan transition. A great number of research findings can be found in various publications. Some software programs that are developed based on these findings are widely used in research work and practical work. Strictly speaking, the 24 hours in a day should be divided into multiple TOD periods for all the coordinated signals in accordance with the macro variation in vehicle demand. The vehicle volumes by movement in each TOD period are collected and analyzed over many days, based on which a TOD period-specific background plan is created for each coordinated signal. The background plans during all the TOD periods are retimed on a regular basis. The truth is that the background plans can hardly be created in that way because of lack of equipment, staff, and funding budgets. Without the vehicle volumes by movement that are as sufficient and accurate as possible, traffic engineers have to roughly partition the TOD periods, invest most of the finite resources into fine-tuning the background plans for the critical TOD periods, and place less emphasis on the quality of the background plans for the non-critical TOD periods. The background plans are passively and irregularly retimed only to reduce complaints from road users.

To implement the actuated logic, traffic detectors should be placed on the approach lanes of the coordinated and uncoordinated phases to sense vehicle demand. The permissive cut-off portions of the coordinated phases and the force-off points of the uncoordinated phases are determined based on the background plan. Green termination conditions are defined for the coordinated and uncoordinated phases by using signal status and vehicle demand. As of now, some off-the-shelf technical solutions are available in placing the traffic detectors and defining the green termination conditions. As a result, the operational performance of the actuated logic will strongly depend on how well the background plans are created.

### SUMMARY

Autonomous control method for actuated coordinated signals (ACM) is developed to address the problems in the existing methods. ACM is applicable to arterials with four-leg signalized intersections that belong to a coordinated signal system.

The functional entities for operating ACM include control center and signal controller. The technical solution of the present invention will be described from ten aspects, i.e., implementation conditions, signal phase settings, timeline, notations, actuated logic, expected greens, background plan, added base greens in the N^{th} cycle, permissive cut-off portions, and force-off points.

### Implementation Conditions

The implementation conditions at the intersection level are as follows.

(1) The intersections are formed by two two-way streets. There is a through vehicle phase and a left-turn vehicle phase on each approach. Through phase is short for the through vehicle phase. Left-turn phase is short for the left-turn vehicle phase;

(2) The through phases are provided with through approach lanes and circular signal indications. The left-turn phases are provided with left-turn approach lanes and arrow signal indications;

(3) The vehicle signals sequentially display “Red”, “Green”, and “Yellow”. The pedestrian signals sequentially display “Red” and “Green”. The signal indications are updated once per second;

(4) Once the timing parameters of the through and left-turn phases are available, they can be used to time other phases with appropriate methods;

(5) A leading phase is the through or left-turn phase that displays green first on the opposing approaches. A lagging phase is the through or left-turn phase that conflicts with the leading phase on the opposing approach. The leading phases are timed with same yellow change interval and same red clearance interval. The lagging phases are timed with same yellow change interval and same red clearance interval;

(6) When a leading phase ends, the opposing lagging phase will display green. The two lagging phases on the opposing approaches must end simultaneously; and

(7) A vehicle detector is placed on each approach lane of the through and left-turn phases, 40 m upstream of the stop line, to detect time headways on a lane-by-lane basis.

The implementation conditions at the arterial level are as follows.

(1) The implementation conditions at the intersection level are available to all the intersections along the arterial;

(2) A control center is established for all the intersections along the arterial. A signal controller is installed at each intersection along the arterial. The control center and the signal controllers can transfer data in real time;

(3) The arterial and the intersecting road are also referred to as the major street and the minor street, respectively;

(4) The through phases on the major street are the coordinated phases. The left-turn phases on the major street and the through and left-turn phases on the minor street are the uncoordinated phases;

(5) The coordinated phases must be distinguished as the critical coordinated phase and the non-critical coordinated phase if two-way signal coordination is implemented on the major street; and

(6) In the background plan, the start of green of the leading phases on the major street is designated as the start of the cycle length and as the programmed start of the background plan. The difference in the starts of green between the critical coordinated phases at adjacent intersections is smaller than the cycle length.

### Signal Phase Settings

The signal phases at the intersection are numbered as follows.

Vehicle Phase K2: the through phase on approach & exit No. 1 of the minor street;

Vehicle Phase K3: the left-turn phase on approach & exit No. 1 of the minor street;

Vehicle Phase K5: the through phase on approach & exit No. 1 of the major street;

Vehicle Phase K6: the left-turn phase on approach & exit No. 1 of the major street;

Vehicle Phase K8: the through phase on approach & exit No. 2 of the minor street;

Vehicle Phase K9: the left-turn phase on approach & exit No. 2 of the minor street;

Vehicle Phase K11: the through phase on approach & exit No. 2 of the major street;

Vehicle Phase K12: the left-turn phase on approach & exit No. 2 of the major street;

Pedestrian Phase F1: the pedestrian phase on approach & exit No. 1 of the minor street;

Pedestrian Phase F2: the pedestrian phase on approach & exit No. 1 of the major street;

Pedestrian Phase F3: the pedestrian phase on approach & exit No. 2 of the minor street; and

Pedestrian Phase F4: the pedestrian phase on approach & exit No. 2 of the major street.

Phases K5 and K11 are the coordinated phases. Phases K2, K3, K6, K8, K9, and K12 are the uncoordinated phases. The intersections along the direction of travel of Phase K11 are numbered from 1 to I.

The phase sequence options on the opposing approaches of the major street are as follows.

(1) Phases K5 and K6 lead Phases K11 and K12;
(2) Phases K5 and K11 lead Phases K6 and K12;
(3) Phases K6 and K12 lead Phases K5 and K11; and
(4) Phases K11 and K12 lead Phases K5 and K6.

The phase sequence options on the opposing approaches of the minor street are as follows.

(1) Phases K2 and K3 lead Phases K8 and K9;

(2) Phases K2 and K8 lead Phases K3 and K9;

(3) Phases K3 and K9 lead Phases K2 and K8; and

(4) Phases K8 and K9 lead Phases K2 and K3.

### Timeline

The background plans are created for all the intersections once per time step. Each time step includes consecutive N cycles.

The control center creates the background plans for all the intersections in each cycle of the 1^{st} time step and sends them to the signal controllers at the programmed start of ACM. The signal controller times the permissive cut-off portions of the coordinated phases and the force-off points of the uncoordinated phases in each cycle of the 1^{st} time step.

The signal controller begins to operate the actuated logic in a second-by-second manner at the programmed start of the background plan in the 1^{st} cycle of the 1^{st} time step.

The signal controller estimates the expected greens for the coordinated and uncoordinated phases in each of the 1^{st} through the (N−1)^{th} cycles of the current time step.

The signal controller sends the expected greens for the coordinated and uncoordinated phases in each of the 1^{st} through the (N−1)^{th} cycles of the current time step to the control center after the N^{th} cycle of the current time step starts. Once the expected greens are received from all the signal controllers, the control center predicts the expected base greens for the coordinated and uncoordinated phases at each intersection in each cycle of the next time step, based on which the background plans for all the intersections in each cycle of the next time step are created and sent to the signal controllers. When the signal controller receives the data, it fine-tunes the background plan, the permissive cut-off portions, and the force-off points in the N^{th} cycle of the current time step so that the background plans can be transitioned from the old one to the new one. In the meantime, the signal controller times the permissive cut-off portions and the force-off points in each cycle of the next time step.

The control center sends a command of stopping the operating procedure of ACM to the signal controllers at the programmed end of ACM. After receiving such a command, the signal controller continues to operate the actuated logic till the current cycle ends. Subsequently, the signal controller can be in any other mode of operation.

### Notations

α=Smoothing factor.
β_{i,Kj}=Percentage of the permissive cut-off portion of Phase Kj at the i^{th} intersection in the base cycle length.
α_{i,Kj}^{m}=Estimated level of the expected base green for Phase Kj at the i^{th} intersection in the m^{th} time step.
A_{i,Kj}^{m}=A_{i,Kj}^{m}=1 if Phase Kj at the i^{th} intersection is the active phase when the signal controller receives the data from the control center in the m^{th} time step, and A_{i,Kj}^{m}=0 if Phase Kj at the i^{th} intersection is the inactive phase when the signal controller receives the data from the control center in the m^{th} time step.
AddBasGᵢ^{m,N}=Added base green for the i^{th} intersection in the N^{th} cycle of the m^{th} time step.
AddBasG_{i,ma}^{m,N}=Added base green for the major street phases at the i^{th} intersection in the N^{th} cycle of the m^{th} time step.
AddBasG_{i,mi}^{m,N}=Added base green for the minor street phases at the i^{th} intersection in the N^{th} cycle of the m^{th} time step.
AddBasG_{i,Kj}^{m,N}=Added base green for Phase Kj at the i^{th} intersection in the N^{th} cycle of the m^{th} time step.
b_{i,Kj}^{m}=Estimated trend of the expected base green for Phase Kj at the i^{th} intersection in the m^{th} time step.
BasC^{m}=Base cycle length in each cycle of the m^{th} time step.
BasC_{i,ma}^{m}=Base cycle length for the major street phases at the i^{th} intersection in each cycle of the m^{th} time step.
BasC_{i,mi}^{m}=Base cycle length for the minor street phases at the i^{th} intersection in each cycle of the m^{th} time step.
BasG_{i,Kj}^{m}=Base green for Phase Kj at the i^{th} intersection in each cycle of the m^{th} time step.
BasOᵢ^{m}=Base plan offset for the i^{th} intersection in each cycle of the m^{th} time step.
BasO_{i,Kj}^{m}=Base phase offset for Phase Kj at the i^{th} intersection in each cycle of the m^{th} time step.
BasS_{i,Kj}^{m}=Base split for Phase Kj at the i^{th} intersection in each cycle of the m^{th} time step.
ConDemP_{i,Kj}^{m,n}=Continued demand period of Phase Kj at the i^{th} intersection in the n^{th} cycle of the m^{th} time step.
d_{i+1,K5→i,K5}=Stop lines spacing between Phase K5 at the (i+1)^{th} intersection and Phase K5 at the i^{th} intersection.
d_{i-1,K11→i,K11}=Stop lines spacing between Phase K11 at the (i−1)^{th} intersection and Phase K11 at the i^{th} intersection.
EffUseG_{i,Kj}^{m,n}=Amount of green time for Phase Kj at the i^{th} intersection that is efficiently used during the protected extended green in the n^{th} cycle of the m^{th} time step.
EPCP_{i,Kj}^{m,n}=Programmed end of the permissive cut-off portion of Phase Kj at the i^{th} intersection in the n^{th} cycle of the m^{th} time step.
ExpBasCᵢ^{m}=Expected base cycle length for the i^{th} intersection in each cycle of the m^{th} time step.
ExpBasC_{i,ma}^{m}=Expected base cycle length for the major street phases at the i^{th} intersection in each cycle of the m^{th} time step.
ExpBasC_{i,mi}^{m}=Expected base cycle length for the minor street phases at the i^{th} intersection in each cycle of the m^{th} time step.
ExpBasG_{i,Kj}^{m}=Expected base green for Phase Kj at the i^{th} intersection in each cycle of the m^{th} time step.
ExpBasS_{i,Kj}^{m}=Expected base split for Phase Kj at the i^{th} intersection in each cycle of the m^{th} time step.
ExpG_{i,Kj}^{m,n}=Expected green for Phase Kj at the i^{th} intersection in the n^{th} cycle of the m^{th} time step.
ExpG(1)_{i,Kj}^{m}=First-order exponential smoothing value of the expected base green for Phase Kj at the i^{th} intersection in the m^{th} time step.
ExpG(2)_{i,Kj}^{m}=Second-order exponential smoothing value of the expected base green for Phase Kj at the i^{th} intersection in the m^{th} time step.
f_{ExpBasG}=Scaling factor of the expected base green.
FO_{i,Kj}^{m,n}=Force-off point of Phase Kj at the i^{th} intersection in the n^{th} cycle of the m^{th} time step.
GapT_{i,Kj}=Gap time for Phase Kj at the i^{th} intersection.
i=Intersection number, i=1, 2, . . . , and I.
IG_{i,Kj}=Intergreen interval for Phase Kj at the i^{th} intersection.
Kj=Coordinated phase number or uncoordinated phase number.
m=Time step number, m=1, 2, . . . , and M.
MaxBasC=Maximum base cycle length.
MaxExpAddG_{i,Kj}=Maximum expected added green for Phase Kj at the i^{th} intersection.
MinG_{i,Kj}=Minimum green for Phase Kj at the i^{th} intersection.
n=Cycle number in a time step, n=1, 2, . . . , and N.
NL_{i,Kj}=Number of the approach lanes for Phase Kj at the i^{th} intersection.
P_{Kj}^{m}=P_{Kj}^{m}=1 if Phase Kj is the critical coordinated phase in the m^{th} time step, and P_{Kj}^{m}=0 if Phase Kj is the non-critical coordinated phase in the m^{th} time step.

PerCutP_{i,Kj}^{m}=Permissive cut-off portion of Phase Kj at the i^{th} intersection in each cycle of the m^{th} time step.

QueSerT_{i,Kj}^{m}=Queue service time for Phase Kj at the i^{th} intersection in each cycle of the m^{th} time step.
RC_{i,Kj}=Red clearance interval for Phase Kj at the i^{th} intersection.
RefBasOᵢ^{m}=Reference base plan offset for the i^{th} intersection in each cycle of the m^{th} time step.
SBPᵢ^{m,n}=Programmed start of the background plan for the i^{th} intersection in the n^{th} cycle of the m^{th} time step.
SPCP_{i,Kj}^{m,n}=Programmed start of the permissive cut-off portion of Phase Kj at the i^{th} intersection in the n^{th} cycle of the m^{th} time step.
SR^{m,n}=Sync reference point in the n^{th} cycle of the m^{th} time step.
START=Programmed start of ACM.
v_{i+1,Kj→i,Kj}^{m}=Designed progression speed of phase Kj between the (i+1)^{th} intersection and the i^{th} intersection in each cycle of the m^{th} time step.
v_{i-1,Kj→i,Kj}^{m}=Designed progression speed of phase Kj between the (i−1)^{th} intersection and the i^{th} intersection in each cycle of the m^{th} time step.
W_{i,Kj}^{m}=Weight factor of Phase Kj at the i^{th} intersection in distributing AddBasGᵢ^{m,N}.
W_{i,ma}^{m}=Weight factor of the major street phases at the i^{th} intersection in distributing AddBasGᵢ^{m,N}.
W_{i,mi}^{m}=Weight factor of the minor street phases at the i^{th} intersection in distributing AddBasGᵢ^{m,N}.
X_{i,Kj}=X_{i,Kj}=1 if Phase Kj at the i^{th} intersection is the leading phase, and X_{i,Kj}=0 if Phase Kj at the i^{th} intersection is the lagging phase.
YC_{i,Kj}=Yellow change interval for Phase Kj at the i^{th} intersection.

### Actuated Logic

The actuated logic is a set of logic rules that are embedded into the signal controller to dynamically adjust the green durations of the coordinated and uncoordinated phases. The green termination conditions of the coordinated and uncoordinated phases are defined to serve the continued demand.

The green termination conditions of the coordinated phase are as follows.

(1) The coordinated phase extends to or beyond the programmed start of the permissive cut-off portion in the current cycle. Meanwhile, the continued demand of the coordinated phase is served, i.e., all the detectors of the coordinated phase respectively detect a time headway greater than the gap time (GapT_{i,Kj}) after the permissive cut-off portion in the current cycle starts; and

(2) The coordinated phase extends to the programmed end of the permissive cut-off portion in the current cycle.

The green termination conditions of the uncoordinated phase are as follows.

(1) The uncoordinated phase reaches the minimum green. Meanwhile, the continued demand of the uncoordinated phase is served, i.e., all the detectors of the uncoordinated phase respectively detect a time headway greater than the gap time (GapT_{i,Kj}) after the minimum green expires; and

(2) The uncoordinated phase extends to the force-off point in the current cycle.

The leading phase, no matter whether it is the coordinated phase or the uncoordinated phase, ends immediately if it meets one of the green termination conditions.

The lagging phase, no matter whether it is the coordinated phase or the uncoordinated phase, ends simultaneously with another lagging phase only when they both meet one of their respective green termination conditions.

### Expected Greens

An expected green (ExpG_{i,Kj}^{m,n}) is the estimated amount of green time that is required to serve the coordinated or uncoordinated phase at the i^{th} intersection in the n^{th} cycle of the m^{th} time step, 1≤n≤N−1.

For the coordinated phase, ExpG_{i,Kj}^{m,n} is the sum of the minimum green (MinG_{i,Kj}), the amount of green time that is efficiently used during the protected extended green (EffUseG_{i,Kj}^{m,n}), and the continued demand period (ConDemP_{i,Kj}^{m,n}), given by Eq. (1).

Exp G_{i,Kj|j=5,11}^{m,n|n∈[1,N-1]}=Min G_{i,Kj}+EffUseG_{i,Kj}^{m,n}+ConDemP_{i,Kj}^{m,n} (1)

The protected extended green is the time that elapses between the end of the minimum green and the programmed start of the permissive cut-off portion, during which the coordinated phase must be served even if there is no demand. Within the range of the protected extended green, the value of EffUseG_{i,Kj}^{m,n} is increased by one second if the time headways detected by half or more of the detectors of the coordinated phase at the end of the second are simultaneously not greater than the gap time (GapT_{i,Kj}).

ConDemP_{i,Kj}^{m,n} is equal to the time that elapses between the programmed start of the permissive cut-off portion and the end of the second at which all the detectors of the coordinated phase respectively detect a time headway greater than GapT_{i,Kj}.Once the value of ConDemP_{i,Kj}^{m,n} extends beyond the programmed end of the permissive cut-off portion, the excess part is limited by the maximum expected added green of the coordinated phase (MaxExpAddG_{i,Kj}).

For the uncoordinated phase, ExpG_{i,Kj}^{m,n} is the sum of the minimum green (MinG_{i,Kj}) and the continued demand period (ConDemP_{i,Kj}^{m,n}), given by Eq. (2).

Exp G_{i,Kj=j≠5,11}^{m,n|n∈[1,N-1]}=Min G_{i,Kj}+ConDemP_{i,Kj}^{m,n} (2)

ConDemP_{i,Kj}^{m,n} is equal to the time that elapses between the end of the minimum green and the end of the second at which all the detectors of the uncoordinated phase respectively detect a time headway greater than GapT_{i,Kj}. Once the value of ConDemP_{i,Kj}^{m,n} extends beyond the force-off point, the excess part is limited by MaxExpAddG_{i,Kj}.

### Background Plan

The timing parameters that define a background plan include: base cycle length, base splits, base greens, base phase offset, base plan offset, and sync reference point. The background plan for each intersection is created to achieve two objectives. First, the base splits are allocated to the coordinated and uncoordinated phases in proportional to their expected base splits. Second, the base phase offset brings into effect accurately.

### (1) Base Cycle Length

An expected base green (ExpBasG_{i,Kj}^{m}) is the predicted amount of green time that is required to serve the coordinated or uncoordinated phase at the i^{th} intersection in each cycle of the m^{th} time step.

In the 1^{st} or the 2^{nd} time step, ExpBasG_{i,Kj}^{m} is set to MinG_{i,Kj}, given by Eq. (3).

ExpBasG_{i,Kj}^{m|m=1,2}=Min G_{i,Kj} (3)

From the 3^{rd} time step on, ExpBasG_{i,Kj}^{m} is predicted by using the double exponential smoothing method. The prediction procedure is presented as follows.

The first-order exponential smoothing value of the expected base green for Phase Kj in the 1^{st} time step (ExpG(1)_{i,Kj}¹) is calculated by Eq. (4). In the 2^{nd} or a subsequent time step, ExpG(1)_{i,Kj}^{m} is calculated by Eq. (5).

$$\begin{matrix}Exp {G ( 1 )}_{i , Kj}^{1} = \frac{{\sum }_{n = 1}^{N - 1} Exp {G}_{i , Kj}^{1 , n}}{( N - 1 )} & ( 4 ) \\ Exp {G ( 1 )}_{i , Kj}^{m \vert m \geq 2} = α \frac{{\sum }_{n = 1}^{N - 1} Exp {G}_{i , Kj}^{m , n}}{( N - 1 )} + ( 1 - α ) Exp {G ( 1 )}_{i , {K}_{j}}^{m - 1} & ( 5 )\end{matrix}$$

The second-order exponential smoothing value of the expected base green for Phase Kj in the 2^{nd} time step (ExpG(2)_{i,Kj}²) is calculated by Eq. (6). In the 3^{rd} or a subsequent time step, ExpG(2)_{i,Kj}^{m} is calculated by Eq. (7).

Exp G(2)_{i,Kj}²=Exp G(1)_{i,Kj}² (6)

Exp G(2)_{i,Kj}^{m|m≥3}=α Exp G(1)_{i,Kj}^{m}+(1−α)Exp G(2)_{i,Kj}^{m-1} (7)

The estimated level and trend of the expected base green for Phase Kj in the 2^{nd} or a subsequent time step (a_{i,Kj}^{m} and b_{i,Kj}^{m}) are calculated by Eqs. (8) and (9), respectively.

$$\begin{matrix}{a}_{i , Kj}^{m \vert m \geq 2} = 2 Exp {G ( 1 )}_{i , Kj}^{m} - Exp {G ( 2 )}_{i , Kj}^{m} & ( 8 ) \\ {b}_{i , Kj}^{m \vert m \geq 2} = \frac{α}{1 - α} [ Exp {G ( 1 )}_{i , Kj}^{m} - Exp {G ( 2 )}_{i , Kj}^{m} ] & ( 9 )\end{matrix}$$

From the 3^{rd} time step on, ExpBasG_{i,Kj}^{m} is calculated by Eq. (10). In order to give more adequate base green to the coordinated or uncoordinated phase with multiple approach lanes, the predicted value of ExpBasG_{i,Kj}^{m} is corrected by using the number of the approach lanes for Phase Kj(NL_{i,Kj}) and the scaling factor of expected base green (f_{ExpBasG}). ExpBasG_{i,Kj}^{m} is set to MinG_{i,Kj} if it is predicted to be smaller than MinG_{i,Kj}.

$$Exp {BasG}_{i , Kj}^{m \vert m \geq 3} = max \{ \begin{matrix}( {a}_{i , Kj}^{m - 1} + {b}_{i , Kj}^{m - 1} ) [ 1 + ( {NL}_{i , Kj} - 1 ) {f}_{ExpBasG} ] \\ Min {G}_{i , Kj}\end{matrix} \qquad ( 10 )$$

The expected base split (ExpBasS_{i,Kj}^{m}) is equal to the expected base green for the coordinated or uncoordinated phase at the i^{th} intersection in each cycle of the m^{th} time step plus the intergreen interval.

The intergreen interval for Phase Kj(IG_{i,Kj}) is equal to the yellow change interval (YC_{i,Kj}) plus the red clearance interval (RC_{i,Kj}), given by Eq. (11).

IG_{i,Kj}=YC_{i,Kj}+RC_{i,Kj} (11)

ExpBasS_{i,Kj}^{m} is calculated by Eq. (12).

ExpBasS_{i,Kj}^{m}=ExpBasG_{i,Kj}^{m}+IG_{i,Kj} (12)

The expected base cycle lengths for the major street phases and the minor street phases at the i^{th} intersection in each cycle of the m^{th} time step (ExpBasC_{i,ma}^{m} and ExpBasC_{i,mi}^{m}) are calculated by Eqs. (13) and (14), respectively.

$$\begin{matrix}Exp {BasC}_{i , ma}^{m} = max \{ \begin{matrix}Exp {BasS}_{i , K 5}^{m} + Exp {BasS}_{i , K 12}^{m} \\ Exp {BasS}_{i , K 11}^{m} + Exp {BasS}_{i , K 6}^{m}\end{matrix} & ( 13 ) \\ Exp {BasC}_{i , m i}^{m} = max \{ \begin{matrix}Exp {BasS}_{i , K 2}^{m} + Exp {BasS}_{i , K 9}^{m} \\ Exp {BasS}_{i , K 8}^{m} + Exp {BasS}_{i , K 3}^{m}\end{matrix} & ( 14 )\end{matrix}$$

The expected base cycle length for the i^{th} intersection in each cycle of the m^{th} time step (ExpBasCᵢ^{m}) is calculated by Eq. (15).

ExpBasCᵢ^{m}=ExpBasC_{i,ma}^{m}+ExpBasC_{i,mi}^{m} (15)

A base cycle length (BasC^{m}) is the programmed cycle length that is used by all the intersections in each cycle of the m^{th} time step.

BasC^{m} is set to the maximum value of ExpBasCᵢ^{m} if the maximum value of ExpBasCᵢ^{m} is smaller than the maximum base cycle length (MaxBasC). BasC^{m} is set to MaxBasC if the maximum value of ExpBasCᵢ^{m} is not smaller than MaxBasC, given by Eq. (16).

$${BasC}^{m} = min {\{}_{MaxBasC}^{max \{ {ExpBasC}_{i}^{m} \vert i = 1 , 2 , … , I \}} \qquad ( 16 )$$

### (2) Base Splits and Base Greens

A base split (BasS_{i,Kj}^{m}) is the programmed portion of the base cycle length that is allocated to the coordinated or uncoordinated phase at the i^{th} intersection in each cycle of the m^{th} time step.

For the i^{th} intersection, BasC^{m} is divided into the base cycle length for the major street phases (BasC_{i,ma}^{m}) and the base cycle length for the minor street phases (BasC_{i,mi}^{m}), given by Eqs. (17) and (18) respectively.

$$\begin{matrix}{BasC}_{i , ma}^{m} = round ( {BasC}^{m} \times \frac{Exp {BasC}_{i , ma}^{m}}{Exp {BasC}_{i}^{m}} ) & ( 17 ) \\ {BasC}_{i , m i}^{m} = {BasC}^{m} - {BasC}_{i , ma}^{m} & ( 18 )\end{matrix}$$

BasC_{i,ma}^{m} is allocated to Phases K5, K11, K6, and K12, obtaining their respective base splits in each cycle of the m^{th} time step (BasS_{i,K5}^{m}, BasS_{i,K11}^{m}, BasS_{i,K6}^{m}, and BasS_{i,K12}^{m}), given by Eqs. (19) through (21).

$$\begin{matrix}{BasS}_{i , Kj \vert j = 5 , 11}^{m} = round ( {BasC}_{i , ma}^{m} \times \frac{Exp {BasS}_{i , Kj}^{m}}{Exp {BasC}_{i , ma}^{m}} ) & ( 19 ) \\ {BasS}_{i , K 6}^{m} = {BasC}_{i , ma}^{m} - {BasS}_{i , K 11}^{m} & ( 20 ) \\ {BasS}_{i , K 12}^{m} = {BasC}_{i , ma}^{m} - {BasS}_{i , K 5}^{m} & ( 21 )\end{matrix}$$

BasC_{i,mi}^{m} is allocated to Phases K2, K8, K3, and K9, obtaining their respective base splits in each cycle of the m^{th} time step (BasS_{i,K2}^{m}, BasS_{i,K8}^{m}, BasS_{i,K3}^{m}, and BasS_{i,K9}^{m}), given by Eqs. (22) through (24).

$$\begin{matrix}{BasS}_{i , Kj \vert j = 5 , 11}^{m} = round ( {BasC}_{i , m i}^{m} \times \frac{Exp {BasS}_{i , Kj}^{m}}{Exp {BasC}_{i , m i}^{m}} ) & ( 22 ) \\ {BasS}_{i , K 3}^{m} = {BasC}_{i , m i}^{m} - {BasS}_{i , K 8}^{m} & ( 23 ) \\ {BasS}_{i , K 9}^{m} = {BasC}_{i , m i}^{m} - {BasS}_{i , K 2}^{m} & ( 24 )\end{matrix}$$

The base green (BasG_{i,Kj}^{m}) is equal to the base split for the coordinated or uncoordinated phase at the i^{th} intersection in each cycle of the m^{th} time step minus the intergreen interval, given by Eq. (25).

BasG_{i,Kj}^{m}=BasS_{i,Kj}^{m}−IG_{i,Kj} (25)

### (3) Base Phase Offset and Base Plan Offset

A base phase offset (BasO_{i,K5}^{m} or BasO_{i,K11}^{m}) is the difference between the programmed start of the critical coordinated phase at the i^{th} intersection and the programmed start of the critical coordinated phase at the most upstream intersection in each cycle of the m^{th} time step.

If Phase K5 is the critical coordinated phase in the m^{th} time step, the (i+1)^{th} intersection is upstream of the i^{th} intersection in the direction of travel of Phase K5. BasO_{i,K5}^{m} is calculated by Eq. (26).

If Phase K11 is the critical coordinated phase in the m^{th} time step, the (i−1)^{th} intersection is upstream of the i^{th} intersection in the direction of travel of Phase K11. BasO_{i,K11}^{m} is calculated by Eq. (27).

$$\begin{matrix} {BasO}_{i , K 5}^{m} = \{ \begin{matrix}0 & i = I \\ {BasO}_{i + 1 , K 5}^{m} + \frac{{d}_{i + 1 , K 5 -> i , K 5}}{{v}_{i + 1 , K 5 -> i , K 5}^{m}} - {QueSerT}_{i , K 5}^{m} & i < I\end{matrix} & ( 26 ) \\ {BasO}_{i , K 11}^{m} = \{ \begin{matrix}0 & i = 1 \\ {BasO}_{i - 1 , K 11}^{m} + \frac{{d}_{i - 1 , K 11 -> i , K 11}}{{v}_{i - 1 , K 11 -> i , K 11}^{m}} - {QueSerT}_{i , K 11}^{m} & i < 1\end{matrix} & ( 27 )\end{matrix}$$

There are only four factors to be considered when calculating BasO_{i,K5}^{m} and BasO_{i,K11}^{m}.

1) The base phase offset for the upstream intersection (BasO_{i+1,K5}^{m} and BasO_{i-1,K11}^{m});

2) The stop lines spacing of the critical coordinated phases between the adjacent intersections (d_{i+1,K5→i,K5} and d_{i-1,K11→i,K11});

3) The designed progression speed of the critical coordinated phases between the adjacent intersections in each cycle of the m^{th} time step (v_{i+1,K5→i,K5}^{m} and v_{i-1,K11→i,K11}^{m}); and

4) The queue service time for the downstream critical coordinated phase in each cycle of the m^{th} time step (QueSerT_{i,K5}^{m} and QueSerT_{i,K11}^{m}).

The base phase offset at the same intersection may vary over time steps. If the critical coordinated phase is the lagging phase, the base split for the leading uncoordinated phase may change as the time step changes. The critical coordinated phases at each intersection may change as the time step changes. Therefore, the programmed start of the background plan in each cycle of the next time step must be adjusted to ensure that the base phase offset can bring into effect accurately in each cycle of the next time step.

A base plan offset (BasOᵢ^{m}) is the time that elapses between the sync reference point and the programmed start of the background plan for the i^{th} intersection in each cycle of the m^{th} time step.

The reference base plan offset for the i^{th} intersection in each cycle of the m^{th} time step (RefBasOᵢ^{m}) is calculated by Eq. (28). RefBasOᵢ^{m} may be negative. To obtain BasOᵢ^{m} that is always non-negative, the minimum value of RefBasOᵢ^{m} for all the intersections is used to correct RefBasOᵢ^{m}, given by Eq. (29).

$$\begin{matrix}{RefBasO}_{i}^{m} = \{ \begin{matrix}{BasO}_{i , K 5}^{m} & ( {P}_{K 5}^{m} = 1 ) \& ( {X}_{i , K 5} = 1 ) \\ {BasO}_{i , K 5}^{m} - {BasS}_{i , K 12}^{m} & ( {P}_{K 5}^{m} = 1 ) \& ( {X}_{i , K 5} = 0 ) \\ {BasO}_{i , K 11}^{m} & ( {P}_{K 11}^{m} = 1 ) \& ( {X}_{i , K 11} = 1 ) \\ {BasO}_{i , K 11}^{m} - {BasS}_{i , K 6}^{m} & ( {P}_{K 11}^{m} = 1 ) \& ( {X}_{i , K 11} = 0 )\end{matrix} & ( 28 ) \\ {BasO}_{i}^{m} = {RefBasO}_{i}^{m} - min \{ {RefBasO}_{i}^{m} \vert i = 1 , 2 , … , I \} & ( 29 )\end{matrix}$$

### (4) Sync Reference Point

A sync reference point (SR^{m,n}) is the standard point in time used to determine the base plan offset in the n^{th} cycle of the m^{th} time step.

In the 1^{st} time step, SR^{1,1} is set to the programmed start of ACM (START). In the 2^{nd} or a subsequent time step, SR^{m,1} is calculated by using SR^{m-1,N}, BasOᵢ^{m-1}, BasC^{m-1}, and BasOᵢ^{m}, given by Eq. (30). The value of (SR^{m,1}−SR^{m-1,N}) will not be smaller than BasC^{m-1} since both BasOᵢ^{m-1} and BasOᵢ^{m} are non-negative.

$${SR}^{m , 1} = \{ \begin{matrix}START & m = 1 \\ {SR}^{m - 1 , N} + max \{ {BasO}_{i}^{m - 1} + {BasC}^{m - 1} - {BasO}_{i}^{m} \vert i = 1 , 2 , … , I \} & m \geq 2\end{matrix} \qquad ( 30 )$$

In the 2^{nd} or a subsequent cycle of the m^{th} time step, SR^{m,n} is calculated by Eq. (31).

SR^{m,n|n∈[2,N]}=SR^{m,n-1}+BasC^{m} (31)

The programmed start of the background plan for the i^{th} intersection in the n^{th} cycle of the m^{th} time step (SBPᵢ^{m,n}) is calculated by Eq. (32).

SBPᵢ^{m,n}=SR^{m,n}+BasOᵢ^{m} (32)

### Added Base Greens in the N^{th} Cycle

The intersection signal operation is in the N^{th} cycle of the current time step when the signal controller receives the new background plan. To transition the background plan from the old one to the new one in the remaining base cycle length, the signal controller must adjust the base cycle length of the N^{th} cycle to allocate extra base greens to some coordinated or uncoordinated phases. Once this is done, the new background plan can start as programmed.

The added base green for the i^{th} intersection in the N^{th} cycle of the m^{th} time step (AddBasGᵢ^{m,N}) is calculated by Eq. (33).

AddBasGᵢ^{m,N}=SBPᵢ^{m+1,1}−SBPᵢ^{m,N}−BasC^{m}. (33)

An active phase is the coordinated or uncoordinated phase that is displaying green or needs to display green in the current cycle when the signal controller receives the new background plan. An inactive phase is the coordinated or uncoordinated phase that has displayed green in the current cycle when the signal controller receives the new background plan. The added base greens are provided only to the active phases.

The weight factor of Phase Kj at the i^{th} intersection in distributing AddBasGᵢ^{m,N} (W_{i,Kj}^{m}) is given by Eq. (34).

$${W}_{i , K j}^{m} = \{ \begin{matrix}{BasG}_{i , K j}^{m} & {A}_{i , K j}^{m} = 1 \\ 0 & {A}_{i , K j}^{m} = 0\end{matrix} \qquad ( 34 )$$

The weight factors of the major street phases and the minor street phases at the i^{th} intersection in distributing AddBasGᵢ^{m,N} (W_{i,ma}^{m} and W_{i,mi}^{m}) are calculated by Eqs. (35) and (36), respectively.

$$\begin{matrix}{W}_{i , ma}^{m} = max \{ \begin{matrix}{W}_{i , K 5}^{m} + {W}_{i , K 12}^{m} \\ {W}_{i , K 11}^{m} + {W}_{i , K 6}^{m}\end{matrix} & ( 35 ) \\ {W}_{i , mi}^{m} = max \{ \begin{matrix}{W}_{i , K 2}^{m} + {W}_{i , K 9}^{m} \\ {W}_{i , K 8}^{m} + {W}_{i , K 3}^{m}\end{matrix} & ( 36 )\end{matrix}$$

AddBasGᵢ^{m,N} is allocated to the major street phases and the minor street phases, obtaining the added base greens for the major street phases and the minor street phases in the N^{th} cycle of the m^{th} time step (AddBasG_{i,ma}^{m,N} and AddBasG_{i,mi}^{m,N}), given by Eqs (37) and (38) respectively.

$$\begin{matrix}{AddBasG}_{i , ma}^{m , N} = \{ \begin{matrix}round ( {AddBasG}_{i}^{m , N} \times \frac{{W}_{i , ma}^{m}}{{W}_{i , ma}^{m} + {W}_{i , mi}^{m}} & {W}_{i , ma}^{m} + {W}_{i , mi}^{m} > 0 \\ 0 & {W}_{i , ma}^{m} + {W}_{i , mi}^{m} = 0\end{matrix} & ( 37 ) \\ {AddBasG}_{i , mi}^{m , N} = {AddBasG}_{i}^{m , N} - {AddBasG}_{i , ma}^{m , N} & ( 38 )\end{matrix}$$

AddBasG_{i,ma}^{m,N} is allocated to Phases K5, K11, K6, and K12, obtaining their added base greens in the N^{th} cycle of the m^{th} time step (AddBasG_{i,K5}^{m,N}, AddBasG_{i,K11}^{m,N}, AddBasG_{i,K6}^{m,N}, and AddBasG_{i,K12}^{m,N}), given by Eqs. (39) through (41).

$$\begin{matrix}{AddBasG}_{i , K j \vert j = 5 , 11}^{m , N} = \{ \begin{matrix}round ( {AddBasG}_{i , ma}^{m , N} \times \frac{{W}_{i , K j}^{m}}{{W}_{i , ma}^{m}} & {W}_{i , ma}^{m} > 0 \\ 0 & {W}_{i , ma}^{m} = 0\end{matrix} & ( 39 ) \\ {AddBasG}_{i , K 6}^{m , N} = {AddBasG}_{i , ma}^{m , N} - {AddBasG}_{i , K 11}^{m , N} & ( 40 ) \\ {AddBasG}_{i , K 12}^{m , N} = {AddBasG}_{i , ma}^{m , N} - {AddBasG}_{i , K 5}^{m , N} & ( 41 )\end{matrix}$$

AddBasG_{i,mi}^{m,N} is allocated to Phases K2, K8, K3, and K9, obtaining their added base greens in the N^{th} cycle of the m^{th} time step (AddBasG_{i,K2}^{m,N}, AddBasG_{i,K8}^{m,N}, AddBasG_{i,K3}^{m,n}, and AddBasG_{i,K9}^{m,N}), given by Eqs. (42) through (44).

$$\begin{matrix}{AddBasG}_{i , K j \vert j = 2 , 8}^{m , N} = \{ \begin{matrix}round ( {AddBasG}_{i , mi}^{m , N} \times \frac{{W}_{i , K j}^{m}}{{W}_{i , mi}^{m}} & {W}_{i , mi}^{m} > 0 \\ 0 & {W}_{i , mi}^{m} = 0\end{matrix} & ( 42 ) \\ {AddBasG}_{i , K 3}^{m , N} = {AddBasG}_{i , mi}^{m , N} - {AddBasG}_{i , K 8}^{m , N} & ( 43 ) \\ {AddBasG}_{i , K 9}^{m , N} = {AddBasG}_{i , mi}^{m , N} - {AddBasG}_{i , K 2}^{m , N} & ( 44 )\end{matrix}$$

It is worth nothing that, for the intersection at which the critical coordinated phase is the lagging phase, the base phase offset may change in the N^{th} cycle because the leading uncoordinated phase is the active phase and receives the added base green.

### Permissive Cut-Off Portions

A permissive cut-off portion (PerCutP_{i,Kj}^{m}) is the rear portion of the base green for the coordinated phase at the i^{th} intersection in each cycle of the m^{th} time step, during which the actuated logic is used to end the coordinated phase, given by Eq. (45),If BasG_{i,Kj}^{m} is close to MinG_{i,Kj}, BasG_{i,Kj}^{m} is the determinant of PerCutP_{i,Kj}^{m}. If BasG_{i,Kj}^{m} is far larger than MinG_{i,Kj}, PerCutP_{i,Kj}^{m} depends mainly on BasC^{m}.

$${PerCutP}_{i , K j \vert j = 5 , 11}^{m} = min \{ \begin{matrix}{BasG}_{i , K j}^{m} - Min {G}_{i , K j} \\ round ( {β}_{i , K j} \times {BasC}^{m} )\end{matrix} \qquad ( 45 )$$

The start and end of the permissive cut-off portion of the coordinated phase at the i^{th} intersection in the n^{th} cycle of the m^{th} time step (SPCP_{i,Kj}^{m,n} and EPCP_{i,Kj}^{m,n}) are calculated by Eqs. (46) and (47), respectively. In the N^{th} cycle of the m^{th} time step, SPCP_{i,Kj}^{m,n} and EPCP_{i,Kj}^{m,n} should be fine-tuned to accommodate the added base greens.

$$\begin{matrix} {SPCP}_{i , K j \vert j = 5 , 11}^{m , n} = {EPCP}_{i , K j}^{m , n} - {AddBasG}_{i , K j}^{m , N} - {PerCutP}_{i , K j}^{m} & ( 46 ) \\ {EPCP}_{i , K j \vert j = 5 , 11}^{m , n} = \{ \begin{matrix}{SBP}_{i}^{m , n} + {BasG}_{i , K j}^{m} + {AddBasG}_{i , K j}^{m , N} & {X}_{i , K j} = 1 \\ {SBP}_{i}^{m , n} + {BasC}_{i , ma}^{m} + {AddBasG}_{i , ma}^{m , N} - {IG}_{i , K j} & {X}_{i , K j} = 0\end{matrix} & ( 47 )\end{matrix}$$

### Force-Off Points

A force-off point (FO_{i,Kj}^{m,n}) is the point in time during the n^{th} cycle of the m^{th} time step at which the uncoordinated phase at the i^{th} intersection must be ended by the actuated logic, given by Eqs. (48) and (49). In the N^{th} cycle of the m^{th} time step, FO_{i,Kj}^{m,n} should be fine-tuned to accommodate the added base greens.

$$\begin{matrix}{FO}_{i , K j \vert j = 6 , 12}^{m , n} = \{ \begin{matrix}{SBP}_{i}^{m , n} + {BasG}_{i , K j}^{m} + {AddBasG}_{i , K j}^{m , N} & {X}_{i , K j} = 1 \\ {SBP}_{i}^{m , n} + {BasC}_{i , ma}^{m} + {AddBasG}_{i , ma}^{m , N} - {IG}_{i , K j} & {X}_{i , K j} = 0\end{matrix} . & ( 48 ) \\ {FO}_{i , K j \vert j = 2 , 3 , 8 , 9}^{m , n} = \{ \begin{matrix}{SBP}_{i}^{m , n} + {BasC}_{i , ma}^{m} + {AddBasG}_{i , ma}^{m , N} + {BasG}_{i , K j}^{m} + {AddBasG}_{i , K j}^{m , N} & {X}_{i , K j} = 1 \\ {SBP}_{i}^{m , n} + {BasC}^{m} + {AddBasG}_{i}^{m , N} - {IG}_{i , K j} & {X}_{i , K j} = 0\end{matrix} . & ( 49 )\end{matrix}$$

The beneficial effect of ACM is summarized as follows. The background plans, the permissive cut-off portions, and the force-off points can be automatically created for four-leg signalized intersections that belong to a coordinated signal system without any manual intervention. Also, the background plans, the permissive cut-off portions, and the force-off points can accommodate the short-term variation in the vehicle demand. The operational objective of actuated signal coordination is achieved in a simple, efficient, and less costly manner.

### DESCRIPTION OF THE DRAWINGS

FIG. 1 exhibits a typical ACM-enabled four-leg signalized intersection.

FIG. 2 exhibits the timeline of ACM.

FIG. 3 exhibits the data flow diagram of predicting the expected base green.

### DETAILED DESCRIPTION

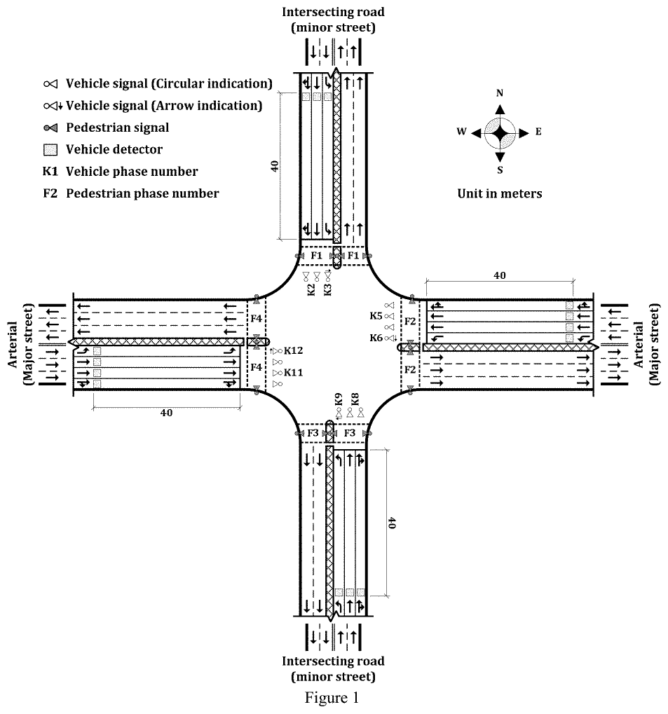

FIG. 1 exhibits a typical ACM-enabled four-leg signalized intersection. No restriction is imposed on the intersection angle. The existence of right-turn lane and right-turn phase on the major street or the minor street will not affect how ACM is applied.

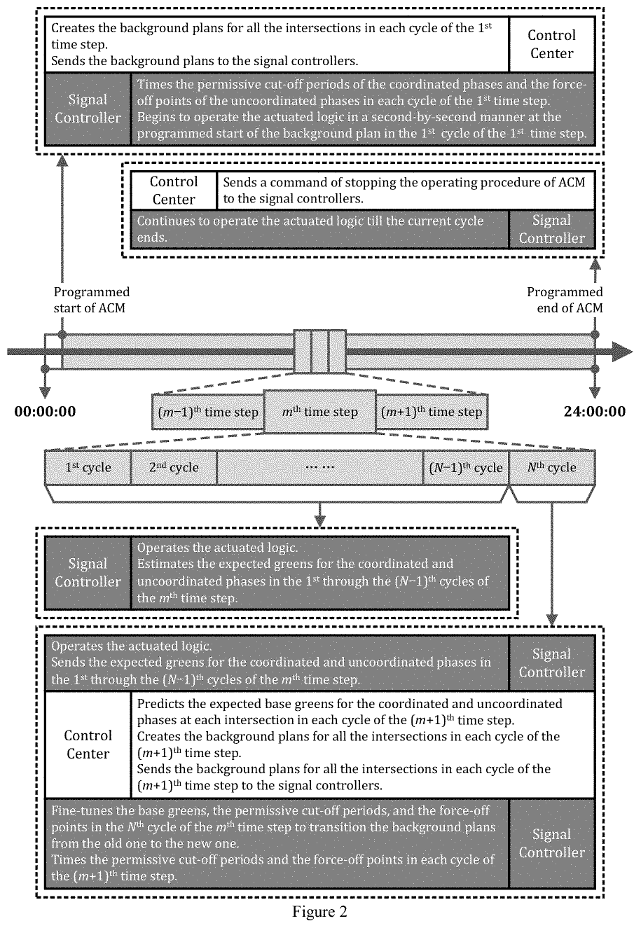

FIG. 2 exhibits the timeline of ACM. The operating procedure of ACM throughout the day starts in the early morning and ends in the late night. If two-way signal coordination is implemented, the control center can change the critical coordinated phases when determining the base phase offsets and the base plan offsets in the next time step.

The control center performs the following operations at the programmed start of ACM.

(1) Calculate the expected base greens and the expected base splits for the coordinated and uncoordinated phases at each intersection in each cycle of the 1^{st} time step;

(2) Calculate the expected base cycle length for each intersection in each cycle of the 1^{st} time step and determine the base cycle length for all the intersections in each cycle of the 1^{st} time step;

(3) Calculate the base splits and the base greens for the coordinated and uncoordinated phases at each intersection in each cycle of the 1^{st} time step;

(4) Calculate the base phase offset and the base plan offset for each intersection in each cycle of the 1^{st} time step;

(5) Calculate the sync reference point in each cycle of the 1^{st} time step; and

(6) Send the background plans for all the intersections in each cycle of the 1^{st} time step to the signal controllers.

The signal controller performs the following operations after receiving the data from the control center at the programmed start of ACM.

(1) Determine the permissive cut-off portions and the force-off points in each cycle of the 1^{st} time step; and

(2) Operate the actuated logic from the programmed start of the background plan in the 1^{st} cycle of the 1^{st} time step.

The signal controller performs the following operations in the 1^{st} through the (N−1)^{th} cycles of the m^{th} time step.

(1) Operate the actuated logic; and

(2) Estimate the expected greens for the coordinated and uncoordinated phases in each cycle;

The signal controller performs the following operations in the N^{th} cycle of the m^{th} time step.

(1) Operate the actuated logic; and

(2) Send the expected greens for the coordinated and uncoordinated phases in each of the 1^{st} through the (N−1)^{th} cycles to the control center.

The control center performs the following operations after receiving the data from all the signal controllers in the N^{th} cycle of the m^{th} time step.

(1) Predict the expected base greens for the coordinated and uncoordinated phases at each intersection in each cycle of the (m+1)^{th} time step. Calculate the expected base splits for the coordinated and uncoordinated phases at each intersection in each cycle of the (m+1)^{th} time step;

(2) Calculate the expected base cycle length for each intersection in each cycle of the (m+1)^{th} time step. Determine the base cycle length for all the intersections in each cycle of the (m+1)^{th} time step;

(3) Calculate the base splits and the base greens for the coordinated and uncoordinated phases at each intersection in each cycle of the (m+1)^{th} time step;

(4) Calculate the base phase offset and the base plan offset for each intersection in each cycle of the (m+1)^{th} time step;

(5) Calculate the sync reference point in each cycle of the (m+1)^{th} time step; and

(6) Send the background plans for all the intersections in each cycle of the (m+1)^{th} time step to the signal controllers.

The signal controller performs the following operations after receiving the data from the control center in the N^{th} cycle of the m^{th} time step.

(1) Calculate the added base greens for the coordinated and uncoordinated phases in the N^{th} cycle of the m^{th} time step;

(2) Update the permissive cut-off portions and the force-off points in the N^{th} cycle of the m^{th} time step; and

(3) Determine the permissive cut-off portions and the force-off points in each cycle of the (m+1)^{th} time step.

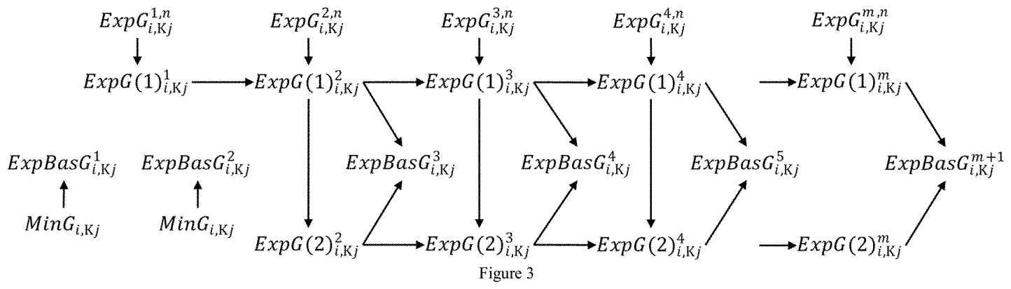

FIG. 3 exhibits the data flow diagram of predicting the expected base green for the coordinated or uncoordinated phase at the i^{th} intersection in the m^{th} time step. The single arrowhead line starts from an input value and points to an output value.

The recommended values of some timing parameters are as follows.

α∈[0.6, 0.9];

β_{i,Kj|j=5,11}=10%;

f_{ExpBasG}=0.05;

GapT_{i,Kj}=3 s;

MaxBasC∈[120, 150](in seconds);

MaxExpAddG_{i,Kj|j=5,11}=10 s;

MaxExpAddG_{i,Kj|j≠5,11}=5 s;

MinG_{i,Kj|j=2,5,8,11}=15 s;

MinG_{i,Kj|j=3,6,9,12}=10 s;

QueSe_{i,Kj}^{m}∈[0, 5](in seconds);

RC_{i,Kj}=2 s; and

YC_{i,Kj}=3 s.

It is recommended that the operation of correcting the predicted value of ExpBasG_{i,Kj}^{m} in the 3^{rd} or a subsequent time step is intended only for the coordinated phases.

1. An autonomous control method for actuated coordinated signals, which is applied to arterials with four-leg signalized intersections that belong to a coordinated signal system; the functional entities of the autonomous control method for actuated coordinated signals include control center and signal controller; the technical solution of the autonomous control method for actuated coordinated signals relates to ten aspects: implementation conditions, signal phase settings, timeline, notations, actuated logic, expected greens, background plan, added base greens in the N^{th} cycle, permissive cut-off portions, and force-off points; the details are as follows:
implementation conditions
the implementation conditions at the intersection level are as follows;
(1) the intersections are formed by two two-way streets; there is a through vehicle phase and a left-turn vehicle phase on each approach; through phase is short for the through vehicle phase; left-turn phase is short for the left-turn vehicle phase;
(2) the through phases are provided with through approach lanes and circular signal indications; the left-turn phases are provided with left-turn approach lanes and arrow signal indications;
(3) the vehicle signals sequentially display Red, Green, and Yellow; the pedestrian signals sequentially display Red and Green; the signal indications are updated once per second;
(4) once the timing parameters of the through and left-turn phases are available, they can be used to time other phases with appropriate methods;
(5) a leading phase is the through or left-turn phase that displays green first on the opposing approaches; a lagging phase is the through or left-turn phase that conflicts with the leading phase on the opposing approach; the leading phases are timed with same yellow change interval and same red clearance interval; the lagging phases are timed with same yellow change interval and same red clearance interval;
(6) when a leading phase ends, the opposing lagging phase will display green; the two lagging phases on the opposing approaches must end simultaneously; and
(7) a vehicle detector is placed on each approach lane of the through and left-turn phases, 40 m upstream of the stop line, to detect time headways on a lane-by-lane basis;
the implementation conditions at the arterial level are as follows;
(1) the implementation conditions at the intersection level are available to all the intersections along the arterial;
(2) a control center is established for all the intersections along the arterial; a signal controller is installed at each intersection along the arterial; the control center and the signal controllers can transfer data in real time;
(3) the arterial and the intersecting road are also referred to as the major street and the minor street, respectively;
(4) the through phases on the major street are the coordinated phases; the left-turn phases on the major street and the through and left-turn phases on the minor street are the uncoordinated phases;
(5) the coordinated phases must be distinguished as the critical coordinated phase and the non-critical coordinated phase if two-way signal coordination is implemented on the major street; and
(6) in the background plan, the start of green of the leading phases on the major street is designated as the start of the cycle length and as the programmed start of the background plan; the difference in the starts of green between the critical coordinated phases at adjacent intersections is smaller than the cycle length;
signal phase settings
the signal phases at the intersection are numbered as follows;
vehicle phase K2: the through phase on approach & exit No. 1 of the minor street;
vehicle phase K3: the left-turn phase on approach & exit No. 1 of the minor street;
vehicle phase K5: the through phase on approach & exit No. 1 of the major street;
vehicle phase K6: the left-turn phase on approach & exit No. 1 of the major street;
vehicle phase K8: the through phase on approach & exit No. 2 of the minor street;
vehicle phase K9: the left-turn phase on approach & exit No. 2 of the minor street;
vehicle phase K11: the through phase on approach & exit No. 2 of the major street;
vehicle phase K12: the left-turn phase on approach & exit No. 2 of the major street;
pedestrian phase F1: the pedestrian phase on approach & exit No. 1 of the minor street;
pedestrian phase F2: the pedestrian phase on approach & exit No. 1 of the major street;
pedestrian phase F3: the pedestrian phase on approach & exit No. 2 of the minor street; and
pedestrian phase F4: the pedestrian phase on approach & exit No. 2 of the major street;
phases K5 and K11 are the coordinated phases; phases K2, K3, K6, K8, K9, and K12 are the uncoordinated phases; the intersections along the direction of travel of phase K11 are numbered from 1 to I;
the phase sequence options on the opposing approaches of the major street are as follows;
(1) phases K5 and K6 lead phases K11 and K12;
(2) phases K5 and K11 lead phases K6 and K12;
(3) phases K6 and K12 lead phases K5 and K11; and
(4) phases K11 and K12 lead phases K5 and K6;
the phase sequence options on the opposing approaches of the minor street are as follows;
(1) phases K2 and K3 lead phases K8 and K9;
(2) phases K2 and K8 lead phases K3 and K9;
(3) phases K3 and K9 lead phases K2 and K8; and
(4) phases K8 and K9 lead phases K2 and K3;
timeline
the background plans are created for all the intersections once per time step; each time step includes consecutive N cycles;
the control center creates the background plans for all the intersections in each cycle of the 1^{st} time step and sends them to the signal controllers at the programmed start of the autonomous control method for actuated coordinated signals; the signal controller times the permissive cut-off portions of the coordinated phases and the force-off points of the uncoordinated phases in each cycle of the 1^{st} time step;
the signal controller begins to operate the actuated logic in a second-by-second manner at the programmed start of the background plan in the 1^{st} cycle of the 1^{st} time step;
the signal controller estimates the expected greens for the coordinated and uncoordinated phases in each of the 1^{st} through the (N−1)^{th} cycles of the current time step;
the signal controller sends the expected greens for the coordinated and uncoordinated phases in each of the 1^{st} through the (N−1)^{th} cycles of the current time step to the control center after the N^{th} cycle of the current time step starts; once the expected greens are received from all the signal controllers, the control center predicts the expected base greens for the coordinated and uncoordinated phases at each intersection in each cycle of the next time step, based on which the background plans for all the intersections in each cycle of the next time step are created and sent to the signal controllers; when the signal controller receives the data, it fine-tunes the background plan, the permissive cut-off portions, and the force-off points in the N^{th} cycle of the current time step so that the background plans can be transitioned from the old one to the new one; in the meantime, the signal controller times the permissive cut-off portions and the force-off points in each cycle of the next time step;
the control center sends a command of stopping the operating procedure of the autonomous control method for actuated coordinated signals to the signal controllers at the programmed end of the autonomous control method for actuated coordinated signals; after receiving such a command, the signal controller continues to operate the actuated logic till the current cycle ends; subsequently, the signal controller can be in any other mode of operation;
notations
α=smoothing factor;
β_{i,Kj}=percentage of the permissive cut-off portion of phase Kj at the i^{th} intersection in the base cycle length;
α_{i,Kj}^{m}=estimated level of the expected base green for phase Kj at the i^{th} intersection in the m^{th} time step;
A_{i,Kj}^{m}=A_{i,Kj}^{m}=1 if phase Kj at the i^{th} intersection is the active phase when the signal controller receives the data from the control center in the m^{th} time step, and A_{i,Kj}^{m}=0 if phase Kj at the i^{th} intersection is the inactive phase when the signal controller receives the data from the control center in the m^{th} time step;
AddBasGᵢ^{m,N}=added base green for the i^{th} intersection in the N^{th} cycle of the m^{th} time step;
AddBasG_{i,ma}^{m,N}=added base green for the major street phases at the i^{th} intersection in the N^{th} cycle of the m^{th} time step;
AddBasG_{i,mi}^{m,N}=added base green for the minor street phases at the i^{th} intersection in the N^{th} cycle of the m^{th} time step;
AddBasG_{i,Kj}^{m,N}=added base green for phase Kj at the i^{th} intersection in the N^{th} cycle of the m^{th} time step;
b_{i,Kj}^{m}=estimated trend of the expected base green for phase Kj at the i^{th} intersection in the m^{th} time step;
BasC^{m}=base cycle length in each cycle of the m^{th} time step;
BasC_{i,ma}^{m}=base cycle length for the major street phases at the i^{th} intersection in each cycle of the m^{th} time step;
BasC_{i,mi}^{m}=base cycle length for the minor street phases at the i^{th} intersection in each cycle of the m^{th} time step;
BasG_{i,Kj}^{m}=base green for phase Kj at the i^{th} intersection in each cycle of the m^{th} time step;
BasOᵢ^{m}=base plan offset for the i^{th} intersection in each cycle of the m^{th} time step;
BasO_{i,Kj}^{m}=base phase offset for phase Kj at the i^{th} intersection in each cycle of the m^{th} time step;
BasS_{i,Kj}^{m}=base split for phase Kj at the i^{th} intersection in each cycle of the m^{th} time step;
ConDemP_{i,Kj}^{m,n}=continued demand period of phase Kj at the i^{th} intersection in the n^{th} cycle of the m^{th} time step;
d_{i+1,K5→i,K5}=stop lines spacing between phase K5 at the (i+1)^{th} intersection and phase K5 at the i^{th} intersection;
d_{i-1,K11→i,K11}=stop lines spacing between phase K11 at the (i−1)^{th} intersection and phase K11 at the i^{th} intersection;
EffUseG_{i,Kj}^{m,n}=amount of green time for phase Kj at the i^{th} intersection that is efficiently used during the protected extended green in the n^{th} cycle of the m^{th} time step;
EPCP_{i,Kj}^{m,n}=programmed end of the permissive cut-off portion of phase Kj at the i^{th} intersection in the n^{th} cycle of the m^{th} time step;
ExpBasCᵢ^{m}=expected base cycle length for the i^{th} intersection in each cycle of the m^{th} time step;
ExpBasC_{i,ma}^{m}=expected base cycle length for the major street phases at the i^{th} intersection in each cycle of the m^{th} time step;
ExpBasC_{i,mi}^{m}=expected base cycle length for the minor street phases at the i^{th} intersection in each cycle of the m^{th} time step;
ExpBasG_{i,Kj}^{m}=expected base green for phase Kj at the i^{th} intersection in each cycle of the m^{th} time step;
ExpBasS_{i,Kj}^{m}=expected base split for phase Kj at the i^{th} intersection in each cycle of the m^{th} time step;
ExpG_{i,Kj}^{m,n}=expected green for phase Kj at the i^{th} intersection in the n^{th} cycle of the m^{th} time step;
ExpG(1)_{i,Kj}^{m}=first-order exponential smoothing value of the expected base green for phase Kj at the i^{th} intersection in the m^{th} time step;
ExpG(2)_{i,Kj}^{m}=second-order exponential smoothing value of the expected base green for phase Kj at the i^{th} intersection in the m^{th} time step;
f_{ExpBasG}=scaling factor of the expected base green;
FO_{i,Kj}^{m,n}=force-off point of phase Kj at the i^{th} intersection in the n^{th} cycle of the m^{th} time step;
GapT_{i,Kj}=gap time for phase Kj at the i^{th} intersection;
i=intersection number, i=1, 2, . . . , and I;
IG_{i,Kj}=intergreen interval for phase Kj at the i^{th} intersection;
Kj=coordinated phase number or uncoordinated phase number;
m=time step number, m=1, 2, . . . , and M;
MaxBasC=maximum base cycle length;
MaxExpAddG_{i,Kj}=maximum expected added green for phase Kj at the i^{th} intersection;
MinG_{i,Kj}=minimum green for phase Kj at the i^{th} intersection;
n=cycle number in a time step, n=1, 2, . . . , and N;
NL_{i,Kj}=number of the approach lanes for phase Kj at the i^{th} intersection;
P_{Kj}^{m}=P_{Kj}^{m}=1 if phase Kj is the critical coordinated phase in the m^{th} time step, and P_{Kj}^{m}=0 if phase Kj is the non-critical coordinated phase in the m^{th} time step;
PerCutP_{i,Kj}^{m}=permissive cut-off portion of phase Kj at the i^{th} intersection in each cycle of the m^{th} time step;
QueSerT_{i,Kj}^{m}=queue service time for phase Kj at the i^{th} intersection in each cycle of the m^{th} time step;
RC_{i,Kj}=red clearance interval for phase Kj at the i^{th} intersection;
RefBasOᵢ^{m}=reference base plan offset for the i^{th} intersection in each cycle of the m^{th} time step;
SBPᵢ^{m,n}=programmed start of the background plan for the i^{th} intersection in the n^{th} cycle of the m^{th} time step;
SPCP_{i,Kj}^{m,n}=programmed start of the permissive cut-off portion of phase Kj at the i^{th} intersection in the n^{th} cycle of the m^{th} time step;
SR^{m,n}=sync reference point in the n^{th} cycle of the m^{th} time step;
START=programmed start of the autonomous control method for actuated coordinated signals;
v_{i+1,Kj→i,Kj}^{m}=designed progression speed of phase Kj between the (i+1)^{th} intersection and the i^{th} intersection in each cycle of the m^{th} time step;
v_{i-1,Kj→i,Kj}^{m}=designed progression speed of phase Kj between the (i−1)^{th} intersection and the i^{th} intersection in each cycle of the m^{th} time step;
W_{i,Kj}^{m}=weight factor of phase Kj at the i^{th} intersection in distributing AddBasGᵢ^{m,N};
W_{i,ma}^{m}=weight factor of the major street phases at the i^{th} intersection in distributing AddBasGᵢ^{m,N};
W_{i,mi}^{m}=weight factor of the minor street phases at the i^{th} intersection in distributing AddBasGᵢ^{m,N};
X_{i,Kj}=X_{i,Kj}=1 if phase Kj at the i^{th} intersection is the leading phase, and X_{i,Kj}=0 if phase Kj at the i^{th} intersection is the lagging phase;
YC_{i,Kj}=yellow change interval for phase Kj at the i^{th} intersection;
actuated logic
the actuated logic is a set of logic rules that are embedded into the signal controller to dynamically adjust the green durations of the coordinated and uncoordinated phases; the green termination conditions of the coordinated and uncoordinated phases are defined to serve the continued demand;
the green termination conditions of the coordinated phase are as follows;
(1) the coordinated phase extends to or beyond the programmed start of the permissive cut-off portion in the current cycle; meanwhile, the continued demand of the coordinated phase is served, i.e., all the detectors of the coordinated phase respectively detect a time headway greater than the gap time, GapT_{i,Kj}, after the permissive cut-off portion in the current cycle starts; and
(2) the coordinated phase extends to the programmed end of the permissive cut-off portion in the current cycle;
the green termination conditions of the uncoordinated phase are as follows;
(1) the uncoordinated phase reaches the minimum green; meanwhile, the continued demand of the uncoordinated phase is served, i.e., all the detectors of the uncoordinated phase respectively detect a time headway greater than the gap time, GapT_{i,Kj},after the minimum green expires; and
(2) the uncoordinated phase extends to the force-off point in the current cycle;
the leading phase, no matter whether it is the coordinated phase or the uncoordinated phase, ends immediately if it meets one of the green termination conditions;
the lagging phase, no matter whether it is the coordinated phase or the uncoordinated phase, ends simultaneously with another lagging phase only when they both meet one of their respective green termination conditions;
expected greens
an expected green, ExpG_{i,Kj}^{m,n}, is the estimated amount of green time that is required to serve the coordinated or uncoordinated phase at the i^{th} intersection in the n^{th} cycle of the m^{th} time step, 1≤n≤N−1;
for the coordinated phase, ExpG_{i,Kj}^{m,n} is the sum of the minimum green, MinG_{i,Kj}, the amount of green time that is efficiently used during the protected extended green, EffUseG_{i,Kj}^{m,n}, and the continued demand period, ConDemP_{i,Kj}^{m,n}, given by Eq. (1);
Exp G_{i,Kj|j=5,11}^{m,n|n∈[1,N-1]}=Min G_{i,Kj}+EffUse_{i,Kj}^{m,n}+ConDemP_{i,Kj}^{m,n} (1);
the protected extended green is the time that elapses between the end of the minimum green and the programmed start of the permissive cut-off portion, during which the coordinated phase must be served even if there is no demand; within the range of the protected extended green, the value of EffUseG_{i,Kj}^{m,n} is increased by one second if the time headways detected by half or more of the detectors of the coordinated phase at the end of the second are simultaneously not greater than the gap time, GapT_{i,Kj};
ConDemP_{i,Kj}^{m,n} is equal to the time that elapses between the programmed start of the permissive cut-off portion and the end of the second at which all the detectors of the coordinated phase respectively detect a time headway greater than GapT_{i,Kj}; once the value of ConDemP_{i,Kj}^{m,n} extends beyond the programmed end of the permissive cut-off portion, the excess part is limited by the maximum expected added green of the coordinated phase, MaxExpAddG_{i,Kj};
for the uncoordinated phase, ExpG_{i,Kj}^{m,n} is the sum of the minimum green, MinG_{i,Kj}, and the continued demand period, ConDemP_{i,Kj}^{m,n}, given by Eq. (2);
Exp G_{i,Kj|j≠5,11}^{m,n|n∈[1,N-1]}=Min G_{i,Kj}+ConDemP_{i,Kj}^{m,n} (2);
ConDemP_{i,Kj}^{m,n} is equal to the time that elapses between the end of the minimum green and the end of the second at which all the detectors of the uncoordinated phase respectively detect a time headway greater than GapT_{i,Kj}; once the value of ConDemP_{i,Kj}^{m,n} extends beyond the force-off point, the excess part is limited by MaxExpAddG_{i,Kj};
background plan
the timing parameters that define a background plan include: base cycle length, base splits, base greens, base phase offset, base plan offset, and sync reference point; the background plan for each intersection is created to achieve two objectives; first, the base splits are allocated to the coordinated and uncoordinated phases in proportional to their expected base splits; second, the base phase offset brings into effect accurately;
(1) base cycle length
an expected base green, ExpBasG_{i,Kj}^{m}, is the predicted amount of green time that is required to serve the coordinated or uncoordinated phase at the i^{th} intersection in each cycle of the m^{th} time step;
in the 1^{st} or the 2^{nd} time step, ExpBasG_{i,Kj}^{m} is set to MinG_{i,Kj}, given by Eq. (3);
ExpBasG_{i,Kj}^{m|m=1,2}=Min G_{i,Kj} (3);
from the 3^{rd} time step on, ExpBasG_{i,Kj}^{m} is predicted by using the double exponential smoothing method;
the expected base split, ExpBasS_{i,Kj}^{m}, is equal to the expected base green for the coordinated or uncoordinated phase at the i^{th} intersection in each cycle of the m^{th} time step plus the intergreen interval;
the intergreen interval for phase Kj, IG_{i,Kj}, is equal to the yellow change interval, YC_{i,Kj}, plus the red clearance interval, RC_{i,Kj}, given by Eq. (11);
IG_{i,Kj}=YC_{i,Kj}+RC_{i,Kj} (11);
ExpBasS_{i,Kj}^{m} is calculated by Eq. (12);
ExpBasS_{i,Kj}^{m}=ExpBasG_{i,Kj}^{m}+IG_{i,Kj} (12);
the expected base cycle lengths for the major street phases and the minor street phases at the i^{th} intersection in each cycle of the m^{th} time step, ExpBasC_{i,ma}^{m} and ExpBasC_{i,mi}^{m}, are calculated by Eqs. (13) and (14), respectively;
$$\begin{matrix}Exp {BasC}_{i , ma}^{m} = max \{ \begin{matrix}Exp {BasS}_{i , K 5}^{m} + Exp {BasS}_{i , K 12}^{m} \\ Exp {BasS}_{i , K 11}^{m} + Exp {BasS}_{i , K 6}^{m}\end{matrix} ; & ( 13 ) \\ Exp {BasC}_{i , mi}^{m} = max \{ \begin{matrix}Exp {BasS}_{i , K 2}^{m} + Exp {BasS}_{i , K 9}^{m} \\ Exp {BasS}_{i , K8}^{m} + Exp {BasS}_{i , K 3}^{m}\end{matrix} ; & ( 14 )\end{matrix}$$
the expected base cycle length for the i^{th} intersection in each cycle of the m^{th} time step, ExpBasCᵢ^{m}, is calculated by Eq. (15);
ExpBasCᵢ^{m}=ExpBasC_{i,ma}^{m}+ExpBasC_{i,mi}^{m} (15);
a base cycle length, BasC^{m}, is the programmed cycle length that is used by all the intersections in each cycle of the m^{th} time step;
BasC^{m} is set to the maximum value of ExpBasCᵢ^{m} if the maximum value of ExpBasCᵢ^{m} is smaller than the maximum base cycle length, MaxBasC; BasC^{m} is set to MaxBasC if the maximum value of ExpBasCᵢ^{m} is not smaller than MaxBasC, given by Eq. (16);
$${BasC}^{m} = min \{ \begin{matrix}max \{ Exp {BasC}_{i}^{m} \vert i = 1 , 2 , … , I \} \\ Max BasC\end{matrix} ; \qquad ( 16 )$$
(2) base splits and base greens
a base split, BasS_{i,Kj}^{m}, is the programmed portion of the base cycle length that is allocated to the coordinated or uncoordinated phase at the i^{th} intersection in each cycle of the m^{th} time step;
for the i^{th} intersection, BasC^{m} is divided into the base cycle length for the major street phases, BasC_{i,ma}^{m}, and the base cycle length for the minor street phases, BasC_{i,mi}^{m}, given by Eqs. (17) and (18) respectively;
$$\begin{matrix}{BasC}_{i , ma}^{m} round ( {BasC}^{m} \times \frac{Exp {BasC}_{i , ma}^{m}}{Exp {BasC}_{i}^{m}} ) ; & ( 17 ) \\ {BasC}_{i , mi}^{m} = {BasC}^{m} - {BasC}_{i , ma}^{m} ; & ( 18 )\end{matrix}$$
BasC_{i,ma}^{m} is allocated to phases K5, K11, K6, and K12, obtaining their respective base splits in each cycle of the m^{th} time step, BasS_{i,K5}^{m}, BasS_{i,K11}^{m}, BasS_{i,K6}^{m}, and BasS_{i,K12}^{m}, given by Eqs. (19) through (21);
$$\begin{matrix}{BasS}_{i , K j \vert j = 5 , 11}^{m} = round ( {BasC}_{i , ma}^{m} \times \frac{Exp {BasS}_{i , K j}^{m}}{Exp {BasC}_{i , ma}^{m}} ) ; & ( 19 ) \\ {BasS}_{i , K 6}^{m} = {BasC}_{i , ma}^{m} - {BasS}_{i , K 11}^{m} ; & ( 20 ) \\ {BasS}_{i , K 12}^{m} = {BasC}_{i , ma}^{m} - {BasS}_{i , K 5}^{m} ; & ( 21 )\end{matrix}$$
BasC_{i,mi}^{m} is allocated to phases K2, K8, K3, and K9, obtaining their respective base splits in each cycle of the m^{th} time step, BasS_{i,K2}^{m}, BasS_{i,K8}^{m}, BasS_{i,K3}^{m}, and BasS_{i,K9}^{m}, given by Eqs. (22) through (24);
$$\begin{matrix}{BasS}_{i , Kj \vert j = 2 , 8}^{m} = round ( {BasC}_{i , m i}^{m} \times \frac{Exp {BasS}_{i , Kj}^{m}}{Exp {BasC}_{i , m i}^{m}} ) ; & ( 22 ) \\ {BasS}_{i , K 3}^{m} = {BasC}_{i , m i}^{m} - {BasS}_{i , K 8}^{m} ; & ( 23 ) \\ {B asS}_{i , K 9}^{m} = {BasC}_{i , m i}^{m} - {BasS}_{i , K 2}^{m} ; & ( 24 )\end{matrix}$$
the base green, BasG_{i,Kj}^{m}, is equal to the base split for the coordinated or uncoordinated phase at the i^{th} intersection in each cycle of the m^{th} time step minus the intergreen interval, given by Eq. (25);
BasG_{i,Kj}^{m}=BasS_{i,Kj}^{m}−IG_{i,Kj} (25);
(3) base phase offset and base plan offset
a base phase offset, BasO_{i,K5}^{m} or BasO_{i,K11}^{m}, is the difference between the programmed start of the critical coordinated phase at the i^{th} intersection and the programmed start of the critical coordinated phase at the most upstream intersection in each cycle of the m^{th} time step;
if phase K5 is the critical coordinated phase in the m^{th} time step, the (i+1)^{th} intersection is upstream of the i^{th} intersection in the direction of travel of phase K5; BasO_{i,K5}^{m} is calculated by Eq. (26);
if phase K11 is the critical coordinated phase in the n^{th} time step, the (i−1)^{th} intersection is upstream of the i^{th} intersection in the direction of travel of phase K11; BasO_{i,K11}^{m} is calculated by Eq. (27);
$$\begin{matrix} {BasO}_{i , K 5}^{m} = \{ \begin{matrix}0 & i = I \\ {BasO}_{i + 1 , K 5}^{m} + \frac{{d}_{i + 1 , K 5 \to i , K 5}}{{v}_{i + 1 , K 5 \to i , K 5}^{m}} - {QueSerT}_{i , K 5}^{m} & i < I\end{matrix} ; & ( 26 ) \\ {BasO}_{i , K 11}^{m} = \{ \begin{matrix}0 & i = 1 \\ {BasO}_{i - 1 , K 11}^{m} + \frac{{d}_{i - 1 , K 11 \to i , K 11}}{{v}_{i - 1 , K 11 \to i , K 11}^{m}} - {QueSerT}_{i , K 11}^{m} & i > 1\end{matrix} ; & ( 27 )\end{matrix}$$
there are only four factors to be considered when calculating BasO_{i,K5}^{m} and BasO_{i,K11}^{m};
(1) the base phase offset for the upstream intersection, BasO_{i+1,K5}^{m} and BasO_{i-1,K11}^{m};
(2) the stop lines spacing of the critical coordinated phases between the adjacent intersections, d_{i+1,K5→i,K5} and d_{i-1,K11→i,K11};
(3) the designed progression speed of the critical coordinated phases between the adjacent intersections in each cycle of the m^{th} time step, v_{i+1,K5→i,K5}^{m} and v_{i-1,K11→i,K11}^{m}; and
(4) the queue service time for the downstream critical coordinated phase in each cycle of the m^{th} time step, QueSerT_{i,K5}^{m} and QueSerT_{i,K11}^{m};
the programmed start of the background plan in each cycle of the next time step is adjusted to ensure that the base phase offset can bring into effect accurately in each cycle of the next time step;
a base plan offset, BasOᵢ^{m}, is the time that elapses between the sync reference point and the programmed start of the background plan for the i^{th} intersection in each cycle of the m^{th} time step;
the reference base plan offset for the i^{th} intersection in each cycle of the m^{th} time step, RefBasOᵢ^{m}, is calculated by Eq. (28); RefBasOᵢ^{m} may be negative; to obtain BasOᵢ^{m} that is always non-negative, the minimum value of RefBasOᵢ^{m} for all the intersections is used to correct RefBasOᵢ^{m}, given by Eq. (29);
$$\begin{matrix}{RefBasO}_{i}^{m} = \{ \begin{matrix}{BasO}_{i , K 5}^{m} & ( {P}_{K 5}^{m} = 1 ) \& ( {X}_{i , K 5} = 1 ) \\ {BasO}_{i , K 5}^{m} - {BasS}_{i , K 12}^{m} & ( {P}_{K 5}^{m} = 1 ) \& ( {X}_{i , K 5} = 0 ) \\ {BasO}_{i , K 11}^{m} & ( {P}_{K 11}^{m} = 1 ) \& ( {X}_{i , K 11} = 1 ) \\ {BasO}_{i , K 11}^{m} - {BasS}_{i , K 6}^{m} & ( {P}_{K 11}^{m} = 1 ) \& ( {X}_{i , K 11} = 0 )\end{matrix} ; & ( 28 ) \\ {BasO}_{i}^{m} = {RefBasO}_{i}^{m} - min \{ {RefBasO}_{i}^{m} \vert i = 1 , 2 , … , I \} ; & ( 29 )\end{matrix}$$
(4) sync reference point
a sync reference point, SR^{m,n}, is the standard point in time used to determine the base plan offset in the n^{th} cycle of the m^{th} time step;
in the 1^{st} time step, SR^{1,1} is set to the programmed start of the autonomous control method for actuated coordinated signals, START; in the 2^{nd} or a subsequent time step, SR^{m,1} is calculated by using SR^{m-1,N}, BasOᵢ^{m-1}, and BasC^{m-1}, and BasOᵢ^{m}, given by Eq. (30); the value of (SR^{m,1}−SR^{m-1,N}) will not be smaller than BasC^{m-1} since both BasOᵢ^{m-1} and BasOᵢ^{m} are non-negative;
$${SR}^{m , 1} = \{ \begin{matrix}START & m = 1 \\ \begin{matrix}{SR}^{m - 1 , N} + \\ max \{ {BasO}_{i}^{m - 1} + {BasC}^{m - 1} - {BasO}_{i}^{m} \vert i = 1 , 2 , … , I \}\end{matrix} & m \geq 2\end{matrix} ; \qquad ( 30 )$$
in the 2^{nd} or a subsequent cycle of the m^{th} time step, SR^{m,n} is calculated by Eq. (31);
SR^{m,n|n∈[2,N]}=SR^{m,n-14}+BasC^{m} (31);
the programmed start of the background plan for the i^{th} intersection in the n^{th} cycle of the m^{th} time step, SRPᵢ^{m,n}, is calculated by Eq. (32);
SBPᵢ^{m,n}=SR^{m,n}+BasOᵢ^{m} (32);
added base greens in the N^{th} cycle
the intersection signal operation is in the N^{th} cycle of the current time step when the signal controller receives the new background plan; to transition the background plan from the old one to the new one in the remaining base cycle length, the signal controller must adjust the base cycle length of the N^{th} cycle to allocate extra base green to some coordinated or uncoordinated phases; once this is done, the new background plan can start as programmed;
the added base green for the i^{th} intersection in the N^{th} cycle of the m^{th} time step, AddBasGᵢ^{m,N},is calculated by Eq. (33);
AddBasGᵢ^{m,N}=SBPᵢ^{m+1,1}−SBPᵢ^{m,N}−BasC^{m} (33);
an active phase is the coordinated or uncoordinated phase that is displaying green or needs to display green in the current cycle when the signal controller receives the new background plan; an inactive phase is the coordinated or uncoordinated phase that has displayed green in the current cycle when the signal controller receives the new background plan; the added base green is provided only to the active phases;
the weight factor of phase Kj at the i^{th} intersection in distributing AddBasGᵢ^{m,N}, W_{i,Kj}^{m}, is given by Eq. (34);
$${W}_{i , Kj}^{m} = \{ \begin{matrix}{BasG}_{i , Kj}^{m} & {A}_{i , Kj}^{m} = 1 \\ 0 & {A}_{i , Kj}^{m} = 0\end{matrix} ; \qquad ( 34 )$$
the weight factors of the major street phases and the minor street phases at the i^{th} intersection in distributing AddBasGᵢ^{m,N}, W_{i,ma}^{m} and W_{i,mi}^{m}, are calculated by Eqs. (35) and (36), respectively;
$$\begin{matrix}{W}_{i , ma}^{m} = max \{ \begin{matrix}{W}_{i , K 5}^{m} + {W}_{i , K 12}^{m} \\ {W}_{i , K 11}^{m} + {W}_{i , K 6}^{m}\end{matrix} ; & ( 35 ) \\ {W}_{i , m i}^{m} = max \{ \begin{matrix}{W}_{i , K 2}^{m} + {W}_{i , K 9}^{m} \\ {W}_{i , K 8}^{m} + {W}_{i , K 3}^{m}\end{matrix} ; & ( 36 )\end{matrix}$$
AddBasGᵢ^{m,N} is allocated to the major street phases and the minor street phases, obtaining the added base greens for the major street phases and the minor street phases in the N^{th} cycle of the m^{th} time step, AddBasG_{i,ma}^{m,N} and AddBasG_{i,mi}^{m,N}, given by Eqs (37) and (38) respectively;
$$\begin{matrix}{AddBasG}_{i , ma}^{m , N} = \{ \begin{matrix}round ( {AddBasG}_{i}^{m , N} \times \frac{{W}_{i , ma}^{m}}{{W}_{i , ma}^{m} + {W}_{i , m i}^{m}} ) & {W}_{i , ma}^{m} + {W}_{i , m i}^{m} > 0 \\ 0 & {W}_{i , ma}^{m} + {W}_{i , m i}^{m} = 0\end{matrix} ; & ( 37 ) \\ {AddBasG}_{i , m i}^{m , N} = {AddBasG}_{i}^{m , N} - {AddBasG}_{i , ma}^{m , N} ; & ( 38 )\end{matrix}$$
AddBasG_{i,ma}^{m,N} is allocated to phases K5, K11, K6, and K12, obtaining their added base greens in the N^{th} cycle of the m^{th} time step, AddBasG_{i,K5}^{m,N}, AddBasG_{i,K11}^{m,N}, AddBasG_{i,K6}^{m,N}, and AddBasG_{i,K12}^{m,N}, given by Eqs. (39) through (41) respectively;
$$\begin{matrix}{AddBasG}_{i , Kj \vert j = 5 , 11}^{m , N} = \{ \begin{matrix}round ( {AddBasG}_{i , ma}^{m , N} \times \frac{{W}_{i , Kj}^{m}}{{W}_{i , ma}^{m}} ) & {W}_{i , ma}^{m} > 0 \\ 0 & {W}_{i , ma}^{m} = 0\end{matrix} ; & ( 39 ) \\ {AddBasG}_{i , K 6}^{m , N} = {AddBasG}_{i , ma}^{m , N} - {AddBasG}_{i , K 11}^{m , N} ; & ( 40 ) \\ {AddBasG}_{i , K 12}^{m , N} = {AddBasG}_{i , ma}^{m , N} - {AddBasG}_{i , K 5}^{m , N} ; & ( 41 )\end{matrix}$$
AddBasG_{i,mi}^{m,N} is allocated to phases K2, K8, K3, and K9, obtaining their added base greens in the N^{th} cycle of the m^{th} time step, AddBasG_{i,K2}^{m,N}, AddBasG_{i,K8}^{m,N}, AddBasG_{i,K3}^{m,N}, and AddBasG_{i,K9}^{m,N}, given by Eqs. (42) through (44) respectively;
$$\begin{matrix}{AddBasG}_{i , Kj \vert j = 2 , 8}^{m , N} = \{ \begin{matrix}round ( {AddBasG}_{i , m i}^{m , N} \times \frac{{W}_{i , Kj}^{m}}{{W}_{i , m i}^{m}} ) & {W}_{i , m i}^{m} > 0 \\ 0 & {W}_{i , m i}^{m} = 0\end{matrix} ; & ( 42 ) \\ {AddBasG}_{i , K 3}^{m , N} = {AddBaG}_{i , m i}^{m , N} - {AddBasG}_{i , K 8}^{m , N} ; & ( 43 ) \\ {AddBasG}_{i , K 9}^{m , N} = {AddBasG}_{i , m i}^{m , N} - {AddBasG}_{i , K 2}^{m , N} ; & ( 44 )\end{matrix}$$
permissive cut-off portions
a permissive cut-off portion, PerCutP_{i,Kj}^{m}, is the rear portion of the base green for the coordinated phase at the i^{th} intersection in each cycle of the m^{th} time step, during which the actuated logic is used to end the coordinated phase, given by Eq. (45);
$${PerCutP}_{i , Kj \vert j = 5 , 11}^{m} = min \{ \begin{matrix}{BasG}_{i , Kj}^{m} - Min {G}_{i , Kj} \\ round ( {β}_{i , Kj} \times {BasC}^{m} )\end{matrix} ; \qquad ( 45 )$$
the start and end of the permissive cut-off portion of the coordinated phase at the i^{th} intersection in the n^{th} cycle of the m^{th} time step (SPCP_{i,Kj}^{m,n} and EPCP_{i,Kj}^{m,n}) are calculated by Eqs. (46) and (47); in the N^{th} cycle of the m^{th} time step, SPCP_{i,Kj}^{m,n} and EPCP_{i,Kj}^{m,n} should be fine-tuned to accommodate the added base greens;
$$\begin{matrix} {SPCP}_{i , Kj \vert j = 5 , 11}^{m , n} = {EPCP}_{i , Kj}^{m , n} - {AddBasG}_{i , Kj}^{m , N} - {PerCutP}_{i , Kj}^{m} ; & ( 46 ) \\ {EPCP}_{i , Kj \vert j = 5 , 11}^{m , n} = \{ \begin{matrix}{SBP}_{i}^{m , n} + {BasG}_{i , Kj}^{m} + {AddBasG}_{i , Kj}^{m , N} & {X}_{i , Kj} = 1 \\ {SBP}_{i}^{m , n} + {BasC}_{i , ma}^{m} + {AddBasG}_{i , ma}^{m , N} - {IG}_{i , Kj} & {X}_{i , Kj} = 0\end{matrix} ; & ( 47 )\end{matrix}$$
force-off points
a force-off point, FO_{i,Kj}^{m,n}, is the point in time during the n^{th} cycle of the m^{th} time step at which the uncoordinated phase at the i^{th} intersection must be ended by the actuated logic, given by Eqs. (48) and (49); in the N^{th} cycle of the m^{th} time step, FO_{i,Kj}^{m,n} should be fine-tuned to accommodate the added base greens;
$$\begin{matrix}{FO}_{i , Kj \vert j = 6 , 12}^{m , n} = \{ \begin{matrix}{SBP}_{i}^{m , n} + {BasG}_{i , Kj}^{m} + {AddBasG}_{i , Kj}^{m , N} & {X}_{i , Kj} = 1 \\ {SBP}_{i}^{m , n} + {BasC}_{i , ma}^{m} + {AddBasG}_{i , ma}^{m , N} - {IG}_{i , Kj} & {X}_{i , Kj} = 0\end{matrix} ; & ( 48 ) \\ {FO}_{i , Kj \vert j = 2 , 3 , 8 , 9}^{m , n} = \{ \begin{matrix}\begin{matrix}{SBP}_{i}^{m , n} + {BasC}_{i , ma}^{m} + {AddBasG}_{i , ma}^{m , N} + \\ {BasG}_{i , Kj}^{m} + {AddBasG}_{i , Kj}^{m , N}\end{matrix} & {X}_{i , Kj} = 1 \\ {SBP}_{i}^{m , n} + {BasC}^{m} + {AddBasG}_{i}^{m , N} - {IG}_{i , Kj} & {X}_{i , Kj} = 0\end{matrix} ; & ( 49 )\end{matrix}$$

2. The autonomous control method for actuated coordinated signals according to claim 1, wherein the double exponential smoothing method is used to predict ExpBasG_{i,Kj}^{m}, based on which ExpBasCᵢ^{m} in the 3^{rd} or a subsequent time step can be calculated; the procedure for predicting ExpBasG_{i,Kj}^{m} is presented as follows;
the first-order exponential smoothing value of the expected base green for phase Kj in the 1^{st} time step, ExpG(1)_{i,Kj}¹, is calculated by Eq. (4); in the 2^{nd} or a subsequent time step, ExpG(1)_{i,Kj}^{m} is calculated by Eq. (5);
$$\begin{matrix}Exp {G ( 1 )}_{i , Kj}^{1} = \frac{{\sum }_{n = 1}^{N - 1} Exp {G}_{i , Kj}^{1 , n}}{( N - 1 )} ; & ( 4 ) \\ Exp {G ( 1 )}_{i , Kj}^{m \vert m \geq 2} = α \frac{{\sum }_{n = 1}^{N - 1} Exp {G}_{i , Kj}^{m , n}}{( N - 1 )} + ( 1 - α ) Exp {G ( 1 )}_{i , Kj}^{m - 1} ; & ( 5 )\end{matrix}$$
the second-order exponential smoothing value of the expected base green for phase Kj in the 2nd time step, ExpG(2)_{i,Kj}², is calculated by Eq. (6); in the 3^{rd} or a subsequent time step, ExpG(2)_{i,Kj}^{m} is calculated by Eq. (7);
Exp G(2)_{i,Kj}²=Exp G(1)_{i,Kj}² (6);
Exp G(2)_{i,Kj}^{m|m≥3}=α Exp G(1)_{i,Kj}^{m}+(1−α)Exp G(2)_{i,Kj}^{m-1} (7);
the estimated level and trend of the expected base green for phase Kj in the 2^{nd} or a subsequent time step, a_{i,Kj}^{m} and b_{i,Kj}^{m}, are calculated by Eqs. (8) and (9), respectively;
$$\begin{matrix}{a}_{i , Kj}^{m \vert m \geq 2} = 2 Exp {G ( 1 )}_{i , Kj}^{m} - Exp {G ( 2 )}_{i , Kj}^{m} ; & ( 8 ) \\ {b}_{i , Kj}^{m \vert m \geq 2} = \frac{α}{1 - α} [ Exp {G ( 1 )}_{i , Kj}^{m} - Exp {G ( 2 )}_{i , Kj}^{m} ] ; & ( 9 )\end{matrix}$$
from the 3^{rd} time step on, ExpBasG_{i,Kj}^{m} is calculated by Eq. (10); in order to give more adequate base green to the coordinated or uncoordinated phase with multiple approach lanes, the predicted value of ExpBasC_{i,Kj}^{m} is corrected by using the number of the approach lanes for phase Kj, NL_{i,Kj}, and the scaling factor of expected base green, f_{ExpBasG}; ExpBasG_{i,Kj}^{m} is set to MinG_{i,Kj} if it is predicted to be smaller than MinG_{i,Kj};
$$Exp {BasG}_{i , Kj}^{m \vert m \geq 3} = max \{ \begin{matrix}( {a}_{i , Kj}^{m - 1} + {b}_{i , Kj}^{m - 1} ) [ 1 + ( {NL}_{i , Kj} - 1 ) {f}_{ExpBasG} \\ Min {G}_{i , Kj}\end{matrix} . \qquad ( 10 )$$
